(19) United States
(12) Patent Application Publication
(10) Pub. No.: US 2011/0153039 A1
(43) Pub. Date: Jun. 23, 2011

(54) SYSTEM AND METHOD FOR PROVIDING DIAGNOSTIC INFORMATION AND GRAPHICAL USER INTERFACE THEREFOR

(76) Inventors: Viktor Gvelesiani, London (CA); Patrick Donald Murphy, London (CA)

(21) Appl. No.: 12/966,705

(22) Filed: Dec. 13, 2010

Related U.S. Application Data
(60) Provisional application No. 61/289,776, filed on Dec. 23, 2009.

(51) Int. Cl. G05B 9/02

(52) U.S. Cl. 700/79

(57) ABSTRACT

It has been recognized that to improve the usability of diagnostic systems and software, such a system can be designed to step the user through a systematic diagnosis of a problem. The process of systematically stepping through the diagnosis can be designed to teach the user how the system operates. In the result, as users gain more knowledge about how the control system operates they can become more efficient at solving problems independently of the diagnostics software. A methodology is utilized which incorporates a hierarchy of conditions in order to drill down into a problem by making one or more simple queries that can be understood without special skills or training.

### CROSS-REFERENCE TO RELATED APPLICATIONS

This application claims priority from U.S. Provisional Application No. 61/289,776 filed on Dec. 23, 2009, the contents of which are incorporated herein by reference.

### TECHNICAL FIELD

The following relates to systems and methods for providing diagnostic information.

### BACKGROUND

Typically, existing diagnostics software, used in troubleshooting control systems for locomotives, only show the user the root problem and often displays any and all problems that need to be resolved as a list of issues but not necessarily in a logical order. This may allow users to rely on such diagnostic software to identify problems for them, but the information provided does not provide the ability to learn from the problems or interrelationships between problems.

### SUMMARY

In one aspect, there is provided a method for providing diagnostic information comprising: detecting a first input indicative of selection of one of a plurality of conditions displayed on a main diagnostics screen; determining if the selected condition has associated therewith, one or more dependent conditions; if said selected condition has one or more dependent conditions, displaying a mapping of said dependent conditions on a new diagnostics screen, at least one of said dependent conditions indicating a problem associated therewith that causes a negative outcome; and upon detecting a second input indicative of selection of said at least one of said dependent conditions, displaying a further mapping of dependent conditions if applicable or displaying diagnostic information associated with said at least one of said dependent conditions.

In another aspect, there is provided, a computer readable storage medium comprising computer executable instructions for providing diagnostic information, the computer executable instructions comprising instructions for: detecting a first input indicative of selection of one of a plurality of conditions displayed on a main diagnostics screen; determining if the selected condition has associated therewith, one or more dependent conditions; if said selected condition has one or more dependent conditions, displaying a mapping of said dependent conditions on a new diagnostics screen, at least one of said dependent conditions indicating a problem associated therewith that causes a negative outcome; and upon detecting a second input indicative of selection of said at least one of said dependent conditions, displaying a further mapping of dependent conditions if applicable or displaying diagnostic information associated with said at least one of said dependent conditions.

In yet another aspect, there is provided, a system for providing diagnostic information, the system comprising a processor and memory, the memory comprising computer executable instructions for: detecting a first input indicative of selection of one of a plurality of conditions displayed on a main diagnostics screen; determining if the selected condition has associated therewith, one or more dependent conditions; if said selected condition has one or more dependent conditions, displaying a mapping of said dependent conditions on a new diagnostics screen, at least one of said dependent conditions indicating a problem associated therewith that causes a negative outcome; and upon detecting a second input indicative of selection of said at least one of said dependent conditions, displaying a further mapping of dependent conditions if applicable or displaying diagnostic information associated with said at least one of said dependent conditions.

### BRIEF DESCRIPTION OF THE DRAWINGS

Embodiments will now be described by way of example only with reference to the appended drawings wherein:

FIG. 1(A) is a schematic diagram of a locomotive comprising an onboard diagnostics application.

FIG. 1(B) is a schematic diagram of a locomotive in communication with a remote diagnostics application.

FIG. 2 is a schematic diagram of an example hierarchy of conditions affecting an outcome.

FIG. 3 is a block diagram illustrating one example configuration for the diagnostics application shown in FIG. 1.

FIG. 4 is an example graphical user interface (GUI) for a main diagnostics menu screen.

FIG. 5 is a flow diagram illustrating a pair of investigative paths to data provided in an output specific UI screen.

FIG. 6A is a an example GUI for an I/O screen.

FIG. 6B is a an example GUI for a radiator fans screen.

FIG. 7 is a an example GUI for a wheel slip screen.

FIG. 8 is a an example GUI for an excitation inquiry screen.

FIG. 9 is a an example GUI for another I/O screen.

FIG. 10 is an example GUI for an overcurrent screen.

FIG. 11 is an example GUI of the overcurrent screen shown in FIG. 10 including a notice of an overcurrent situation.

FIG. 12 is a an example GUI for an Okay to Load dependent outputs diagnostics screen.

FIG. 13 is a an example GUI for an excitation enabled dependent outputs diagnostics screen.

FIG. 14 is flow chart illustrating a set of example computer executable instructions for utilizing the diagnostics application.

### DETAILED DESCRIPTION OF THE DRAWINGS

It will be appreciated that for the sake of illustration, the following examples will be made in the context of locomotives and control systems therefore, however, the principles discussed herein are equally applicable to diagnostics software for any general or specific system that comprises various inputs, outputs, conditions, outcomes, and dependencies therebetween.

It has been recognized that to improve the usability of diagnostic systems and software, such a system can be designed to step the user through a systematic diagnosis of a problem. The process of systematically stepping through the diagnosis can be designed to teach the user how the system operates. In the result, as users gain more knowledge about how the control system operates they can become more efficient at solving problems independently of the diagnostics software.

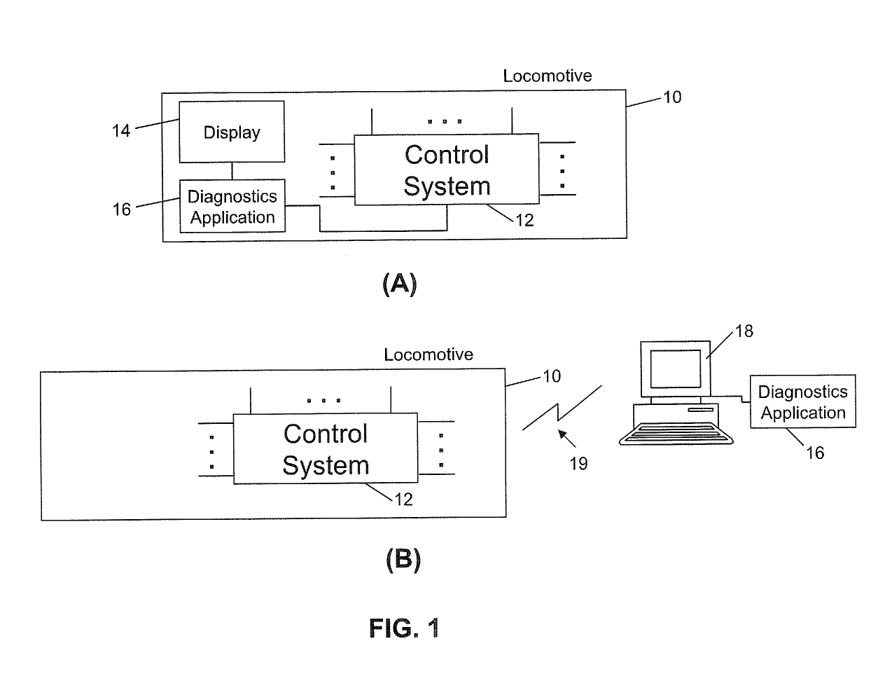

Turning now to FIG. 1, a locomotive 10 is shown without specific detail for clarity. The locomotive 10 comprises a control system 12, which generally represents a system used to monitor and control locomotive 10 and locomotive consist operations such as wheel slip, dynamic braking, over current, cooling (radiator fans), loading, etc. as is well known in the art. A suitable control system is the Nexsys II™ locomotive control system sold by ZTR Control Systems™. In view (A), the locomotive 10 comprises an on-board display 14 for providing an operator interface to the locomotive 10 which in this example includes a graphical user interface (GUI) to the control system 12. A diagnostics application 16 provides such a GUI to enable the operator to interact with the control system 12 to perform diagnostics, monitor system conditions, perform tests, etc. In particular, the diagnostics application 16 eliminates the need to formulate or ask difficult questions regarding how the control system 12 works thus allowing operators of the locomotive 10 that may have specific skills in one area, but not necessarily the control system 12, to diagnose and even remedy problems.

Also shown in FIG. 1 is a view (B) which illustrates another embodiment which may be provided instead of or in addition to the configuration shown in view (A). In view (B), it can be seen that the diagnostics application 16 is accessed and displayed by a remote computing device such as a personal computer (PC) 18. In this embodiment, the diagnostics application 16 is “offline” with respect to the control system 12 but can enable a remote operator to communicate with a local technician or operator over a communication connection 19 to diagnose problems with the control system 12 residing on a locomotive 12 without requiring the locomotive 10 to have the diagnostics application 16 installed. In other embodiments, the diagnostics application 16 can be provided by a server (not shown) which communicates with the locomotive 10 via a wireless communication connection thus providing an online but remote service.

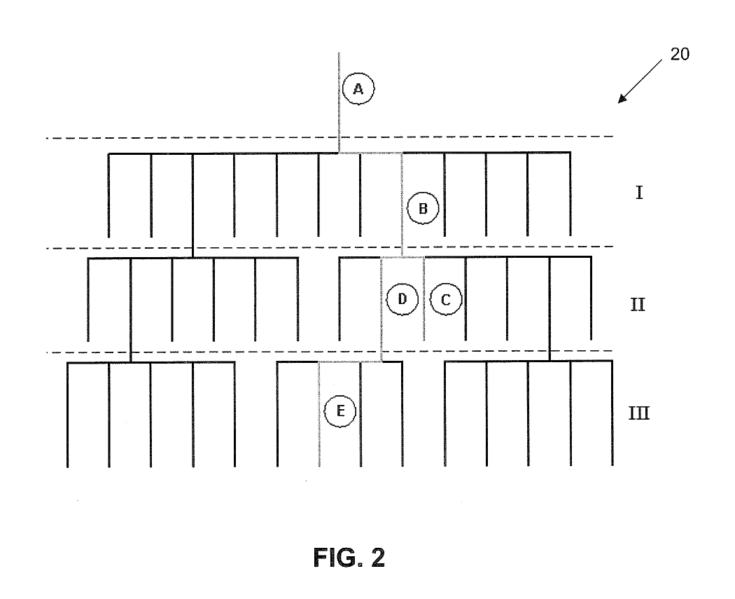

The diagnostics application 16 provides a methodology to assist in troubleshooting the status of an output or the reason for a malfunction in a locomotive 12, and typically achieves this by interfacing with the control system 12 or one or more sub-systems in the locomotive 10 (not shown for clarity). The methodology incorporates a hierarchy of conditions in order to drill down into a problem by making one or more simple queries that can be understood without special skills or training. FIG. 2 illustrates an example conditions hierarchy 20, wherein each vertical line represents a condition of a system that affects an outcome, and each horizontal line represents a separation between different levels of conditions. In the example shown in FIG. 2, there are three levels, namely I, II, and III. The solid horizontal lines join sets of conditions to form groups that affect a single outcome and when a particular condition and its corresponding vertical line extends to another level, this indicates that the outcome of the particular condition is dependent on at least one additional condition that may or may not itself be dependent on at least one additional condition at yet another level.

In the example shown in FIG. 2, condition A represents the final outcome of a number of conditions. The GUI that is provided by the diagnostics application 16 is configured to only display one level at a time and only the conditions for a single outcome in order to assist the operator in isolating problems. On level I, there are 12 conditions that affect the outcome of condition A. Of the 12 conditions on level I, condition B is identified as the cause for the unsatisfactory condition for A. Therefore, in order to further investigate, the GUI can be configured to allow the operator to drill down into condition B, which would then identify 7 conditions on level II that can affect condition B. For example, the operator can display level II by clicking or otherwise selecting condition B in the GUI to navigate to level II to display only the 7 conditions associated with condition B. In order to isolate the problem, only the 7 conditions related to condition B should be shown. In this example, conditions C and D are causing the unsatisfactory condition of B. Condition C is a root level cause because there are no additional levels below it. Therefore, condition C can be investigated on its own to resolve whatever problem makes it unsatisfactory. However, there are four conditions that affect condition D, and by selecting condition D, the operator can drill down further into level III to find that condition E is the root cause for the outcome of condition D. By navigating through the various levels, e.g. as shown in this example, the operator can easily isolate and identify root causes to what would otherwise appear to be a complex problem due to the many inter-dependencies that are inherent in the system or sub-system being investigated using the diagnostics application 16. In this example, the final outcome of condition A can be resolved by correcting conditions E and C, which would in turn ultimately correct conditions D and B along the way. The GUI can be configured to update the output in real-time to show the conditions as they are resolved to therefore provide immediate feedback to the operator.

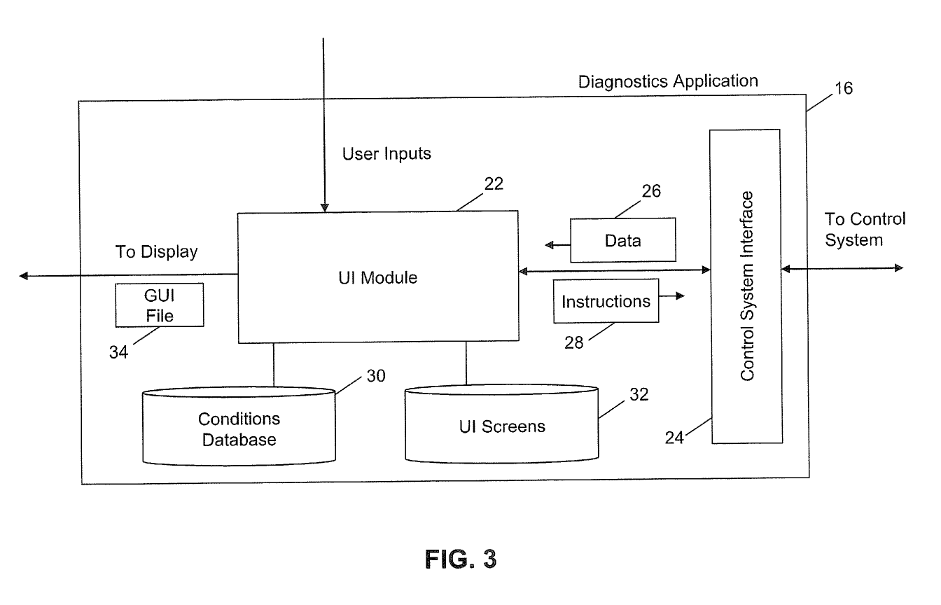

One example configuration for the diagnostics application 16 is shown in FIG. 3. The diagnostics application 16 may be part of a wider software-based suite or may be a stand-alone program that can be initiated or loaded on a computing device (either custom or existing), displayed on a display 14 such as a computer screen or equipment monitor and can be interacted with by an operator through one or more user input devices such as a mouse, touch screen, control panel, keyboard, etc. In this example, the diagnostics application 16 comprises a UI module 22 that interfaces with the control system 12 (or other system or sub-system) through a control system interface 24. This allows the diagnostics application 16 to obtain data 26 from the control system 12 and provide instructions 28, e.g. to turn on or turn off various features or components to assist in trouble-shooting or diagnosing a problem. The UI module 22 uses the data to generate a GUI file 34 that is of a format suitable to be displayed on the display 14 or computing device screen, etc. The GUI file 34 comprises one or more UI screens that are obtained from, in this example, a UI screens database 32, which are accessed according to user inputs and according to conditions stored in, this example, a conditions database 30. In this way, a main GUI file 34 can be used to display a main menu that then allows the operator to interact with the menu to load new screens in accordance with the conditions between the UI screens in the conditions database 30 to then control the generation of new GUI files 34 to refresh the display 14. Moreover, the conditions dependent on particular outcomes, e.g. as illustrated in FIG. 2 can be controlled in order to facilitate isolation of a problem or fault. It can be appreciated that the configuration shown in FIG. 3 is only one example and other configurations are possible. It will also be appreciated that the UI screens and conditions are shown in FIG. 3 as being stored in databases 30, 32, such data can be stored in any suitable format using any suitable data storage device or mechanism and/or may form part of another module and not necessarily require a separate data structure. The configuration shown in FIG. 3 is therefore for illustrative purposes only.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the diagnostics application 16, control system 12 or other portion of the locomotive 10 itself, or accessible or connectable thereto. Any application or module herein described may be implemented using computer readable/executable instructions that may be stored or otherwise held by such computer readable media.

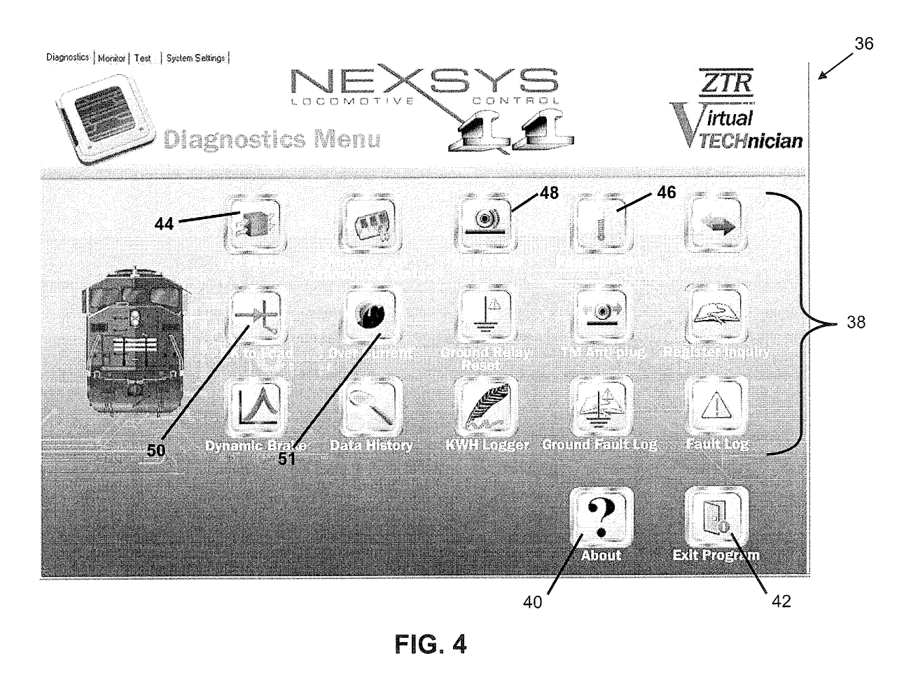

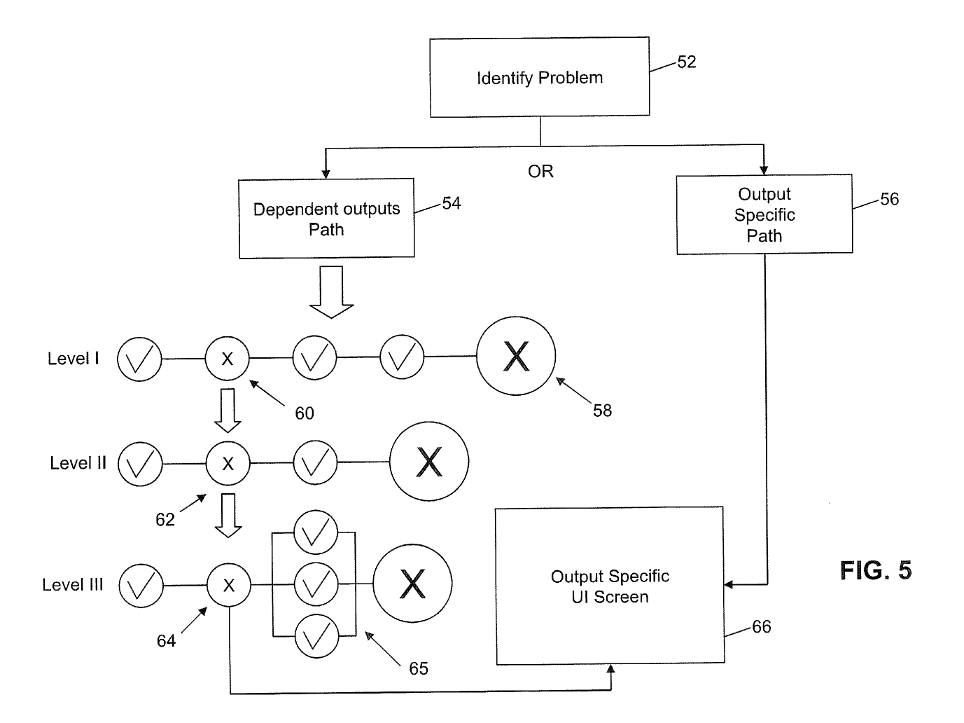

FIG. 4 illustrates an example main diagnostics menu screen 36 that can be initiated by the operator in any suitable manner depending on the nature of the interface provided in the locomotive 10 or the computing device 18. For example, an icon (not shown) in a home screen can be selected, or a button or other hard input can be provided to launch the diagnostics application 16. The menu screen 36 comprises a series of icons 38 that correspond to a feature, sub-system, component, process or any other aspect of the control system 12 that can be monitored, diagnosed, and even controlled through the diagnostics application 16. The menu screen 36 may also provide a help icon 40 to provide a link to tips, FAQs, troubleshooting guides, etc.; and an exit icon 42 to enable the diagnostics application 16 to be closed.

Selection of any one of the icons 38 provides access to further data pertaining to the corresponding feature, sub-system, component, process, or aspect of the control system 12. Depending on whether or not the icon 38 represents a root condition or a the icon 38 represents something that is dependent on one or more conditions beneath it in the hierarchy 20, the operator will enter a dependent outputs path 54 or an output specific path 56 (see FIG. 5 also). For the purpose of illustrating various examples, certain ones of the icons 38 are identified in FIG. 4, namely an I/O status icon 44, a radiator fans icon 46, a wheel slip icon 48, an Ok to Load icon 50, and an over current icon 51. When a corresponding aspect of the control system 12 is experiencing a problem, a specific icon 38 (or icons 38 if applicable) can be modified to shown a different colour or posses some other identifier to distinguish it from a problem-free condition. For example, red can be used to identify problems and green to identify working conditions.

Turning now to FIG. 5, the paths 54, 56 noted above are shown in one example. Once a problem is identified at 52 (e.g. upon detecting user input regarding selection of an icon 38 from the main screen 36), one of the paths 54, 56 would be entered. When the selected icon 38 is a dependent condition and thus has one or more other conditions affecting it, the dependent outputs path 54 is taken, and a representation or mapping of dependencies is shown for the first level (e.g. level I in FIG. 2). In this example, the final outcome 58 which is to be investigated is shown along with its dependent conditions, one of which indicates a first problem condition 60. By selecting the first problem condition 60, the next level of the hierarchy 20 is provided replacing what was shown for level I. At level II, a second problem condition 62 is identified, which enables the operator to further drill down into this condition. A third level is then displayed replacing the display for level II, and in this example shows a third problem condition 64. It may also be noted that at levels I and II, a single path of dependent conditions affects the outcome at that level. However, it can be appreciated that multi-path levels are possible, which may include parallel paths as shown for level III, wherein if one path has a problem the overall condition does not necessarily indicate a problem. In other words, at least one of the conditions in a parallel path needs to be satisfied (a check mark) in order to have a positive effect on the overall outcome.

By selecting the third problem condition 64 in the level III display, in this example, there are no further dependencies, i.e. the third problem condition 64 is a root condition, and thus an output specific UI screen is displayed at 66 to show details specific to the third problem condition 64 to enable this condition to be remedied. The dependent outputs path 54 therefore steps the operator through the various dependencies to allow them to drill down into the problem using a particular set of simple queries until the root problem is discovered. This can accommodate relatively low skill levels with respect to the control system 12. To accommodate easier queries or for more sophisticated skill levels, the output specific path 56 can be configured to enable the operator to proceed directly to the output specific UI screen at 66, e.g. by selecting a specific icon 38 that can be identified by the operator without going through the set of queries in the dependent outputs path 54. In this way, the diagnostics application 16 provides two ways to arrive at the information necessary to remedy a problem while accommodating varying levels of skill. Moreover, more skilled operators can jump directly to problems by accessing particular output specific UI screens 66 and then may investigate dependencies as they fix them by changing to the dependent outputs path 54 to see when inter-dependencies could have affected the end result. Therefore, even operators with higher skill levels can harness the varied approaches and paths to arrive at the source of a problem and to investigate dependent causes and effects, either online or offline at a later time.

It will be appreciated that although FIG. 5 illustrates that the root problem, namely the third problem condition 64, has an output specific UI screen 60 associated with it, not every root problem condition necessarily has a corresponding output specific UI screen 60. For example, if the root problem is a binary condition and its presence or absence can be determined simply from the check mark or X on the display, a more detailed output specific UI screen 66 may not be required.

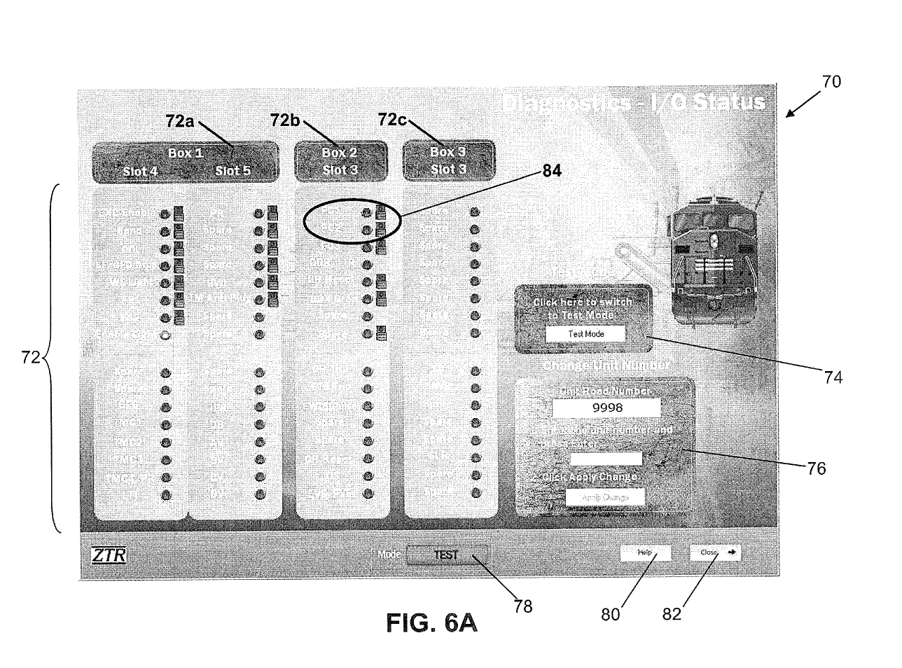

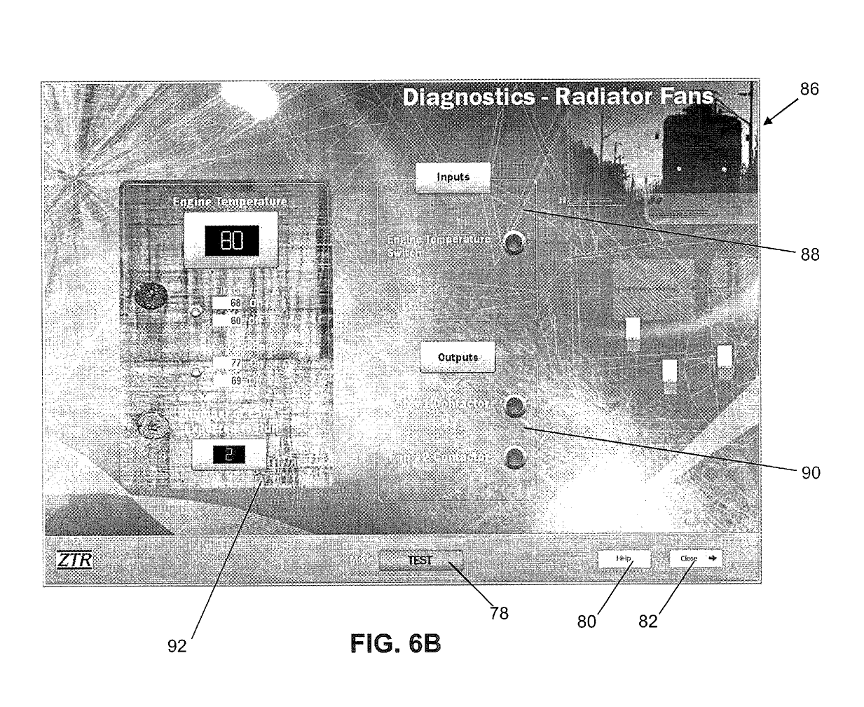

FIG. 6A illustrates an I/O status screen 70 that can be initiated by selecting the I/O status icon 44 from the main screen 36. The I/O status screen 70 in this example is meant to provide a virtual representation of the actual inputs and outputs as seen on a physical control system component. In this example, a series of boxes 72 are displayed, each comprising one or more slots listing various inputs and outputs, some of which, if applicable, include soft switches 84 that enable components of the system to be turned on or off to assist in diagnosing a problem. For example, the soft switch 84 can be used to turn off a component such as a fan to allow a technician to check and/or repair the fan. Then, the soft switch 84 can be used to turn the fan back on and the diagnostics application 16 used to determine if the problem has been solved, e.g. by navigating to the appropriate screens to make this determination. FIG. 6A includes a display representing three physical boxes. Each box contains an I/O rack, and each rack and thus each box can hold up to 5 I/O modules which are typically either analog or digital (discrete) modules. Each I/O module is associated with a slot number on the rack. FIG. 6A is displaying all discrete I/O modules in their respective boxes and slot numbers. In this example, Box 1 72a comprises discrete modules in slots 4 and 5, Box 2 72b comprises a discrete module in slot 3, and Box 3 comprises a discrete module in slot 3. It can be appreciated that there may be analog modules in the slots not displayed or the slots may be empty.

A test mode control 74 is also shown, which can be used to switch to test mode in order to diagnose a problem. A mode indicator 78 may be provided in a status portion of the screen 70 as shown. A unit number control 76 is also provided which shows the current unit number but also enables a unit number to be entered and the change to be applied. In this example, clicking on the test mode button causes the Unit Road Number to automatically change to 9998. As long as the Unit Road Number is 9998 the controller will be in Test Mode. To put the controller in operational mode the user enters the actual Unit Road Number assigned to the locomotive. The Unit Road Number is used by the software application as a reference number when creating reports. A help button 80 can also be provided in the status portion to launch any available help files or tutorials and a close button 82 can be used to close the current screen 70.

In FIG. 6A, FC1 and FC2 outputs are highlighted along with their corresponding soft switches 84 and corresponding output status light. By selecting the corresponding output status light, details of that particular output can be selected and displayed to troubleshoot. FIG. 6B illustrates an example radiator fans screen 86 that displays components affecting the behaviour of the FC1 or FC2 outputs. It may be noted that, as shown in FIG. 4, by selecting the radiator fans icon 46, the radiator fans screen 86 can be initiated directly. Therefore, it can be seen that the I/O status screen 70 also provides a dependent outputs path 54 to arrive at an output specific UI screen 66 without necessarily providing a mapping such as that shown in FIG. 5. The radiator fans screen 86 in this example provides engine temperature information 92 along with the temperature set points (high and low) for turning the first and second fans on and off. At the displayed temperature, the engine temperature information 92 also indicates the number of fans that are expected to run, in this example 2. The radiator fans inputs 88 are also displayed, along with the radiator fan outputs 90. In this example, the inputs 88 includes an engine temperature switch, and its status can be indicated using an output status light similar to the boxes 72 shown in FIG. 6A. The outputs 90 includes the fan contactor for fan 1 and fan 2, with corresponding output status lights. The status lights should show both fans running in this example since the set points indicate that both fans are required. If one or both of the fans are not running, the input, namely the engine temperature switch can be investigated.

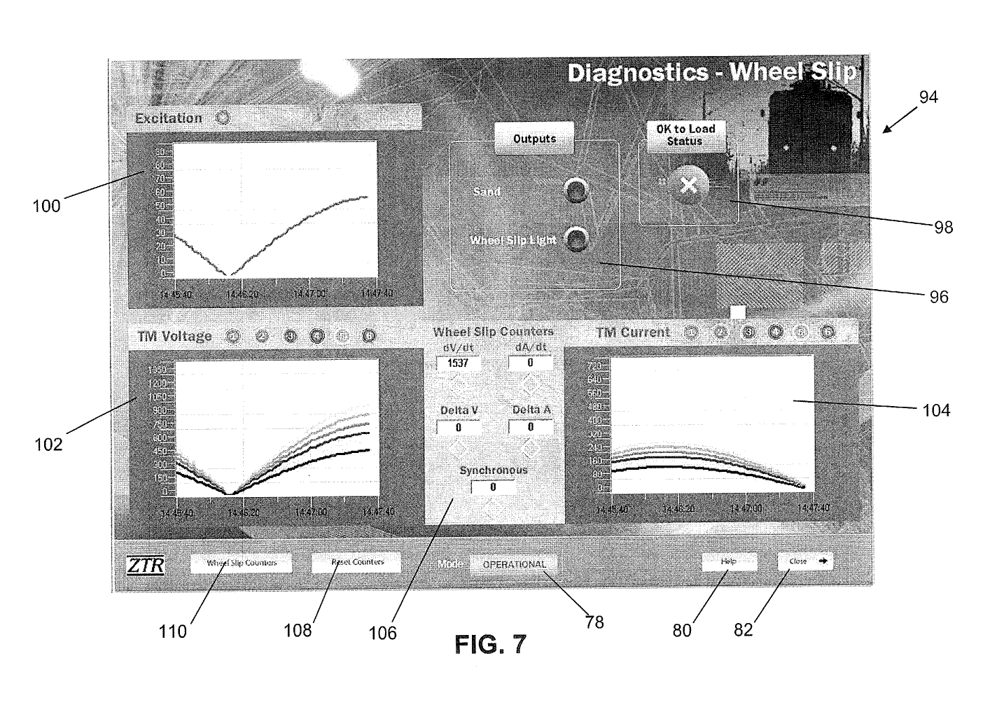

FIG. 7 illustrates an example wheel slip screen 94, which can be initiated by selecting the wheel slip icon 48 in the main screen 36 or by landing on this screen through the functional diagnostics path 54. The wheel slip screen 94 displays the outputs 96, in this example sand and wheel slip light, as well as an Ok to Load Status 98 which, in this example is showing a problem (indicated by the X). An excitation curve 100 is displayed to show the excitation information in real time when in operational mode as indicated in this example by the mode indicator 78. The traction motor (TM) voltage curve 102 and TM current curve 104 are also shown in real time. Various wheel slip counters are displayed with corresponding diamond shaped indicators 106 that can be highlighted to indicate when the excitation is being limited or otherwise affected. A wheel slip counter button 110 is provided to navigate to another screen which has more detailed information about the types of wheel slips that have occurred. For example, the system can use counters to track dv/dt slips for each traction motor separately. A reset counters button 108 is also provided. At the beginning of a test run the user would click this button to clear all the wheel slip counters to zero. At the end of a test run the user would check the wheel slip counters to see which types of slips have occurred.

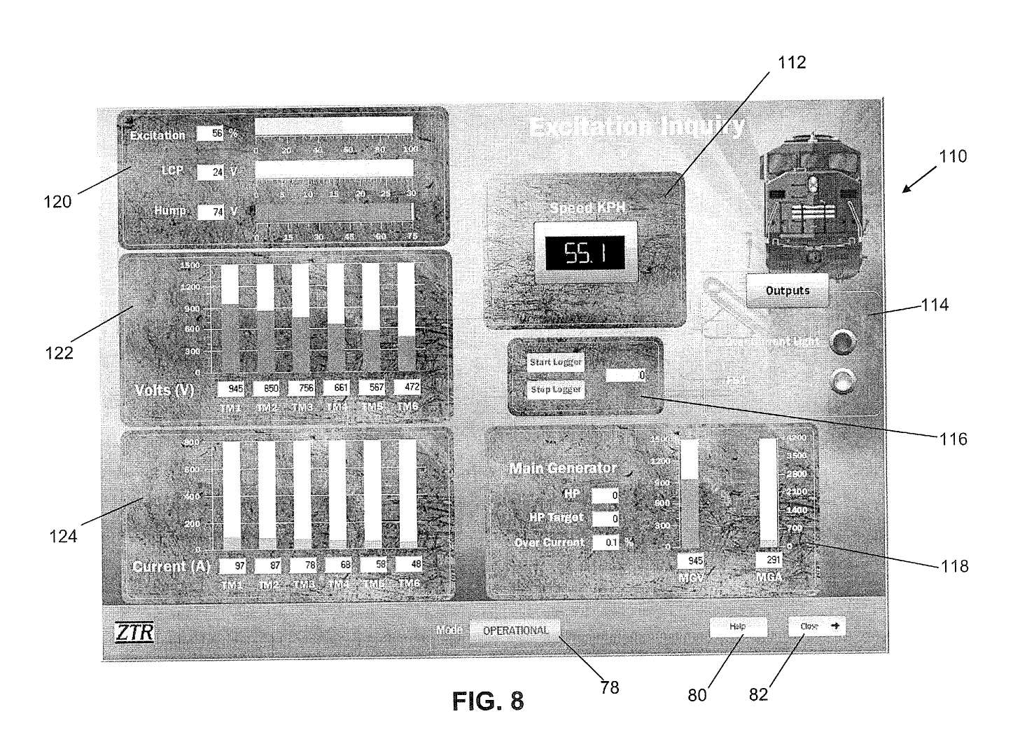

FIG. 8 illustrates an excitation inquiry screen 110, which can be accessed from the monitor tab seen on the top of the main screen 36 shown in FIG. 4. The excitation inquiry screen 110 comprises a speed indicator 112, output display 114 (including over current light and FS1), and a logger information display 116 comprising start logger and stop logger buttons and a log total. A main generator display 118 is also shown which includes HP, HP target, over current value and MGV and MGA gauges. The HP target is the horse power setpoint that the system is trying to reach. When the Over Current value reaches a high setpoint value, power to the traction motors is reduced to protect them from damage due to over heating. The MGV and MGA are main generator voltage and current values. An upper set of gauges 120 shows excitation, LCP and Hump values, a mid set of gauges 122 displays voltage for the traction motors TM1, TM2, TM3, TM4, TM5, and TM6 in this example, and a lower set of gauges 124 shows current for TM1, TM2, TM3, TM4, TM5, and TM6.

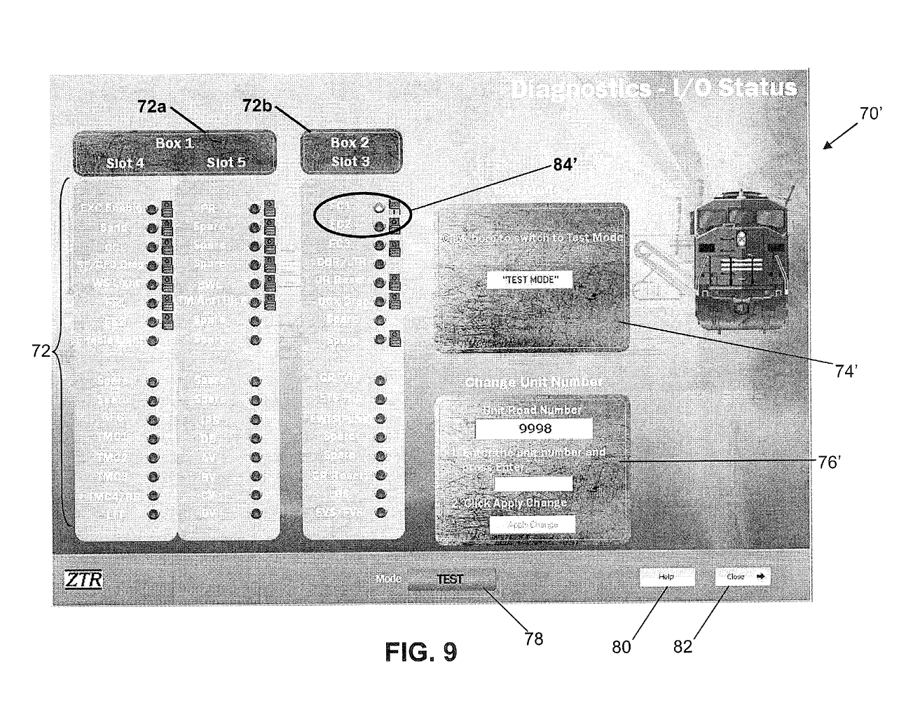

FIG. 9 illustrates another view of the I/O status screen 70′, wherein a soft switch 84′ for FC1 has been activated, which turns on the FC1 output. It can be seen that FIG. 9 illustrates a similar screen as FIG. 6A wherein the screen in FIG. 6A displays the modules of a 3 Box system and FIG. 9 displays a screen for a 2 Box system.

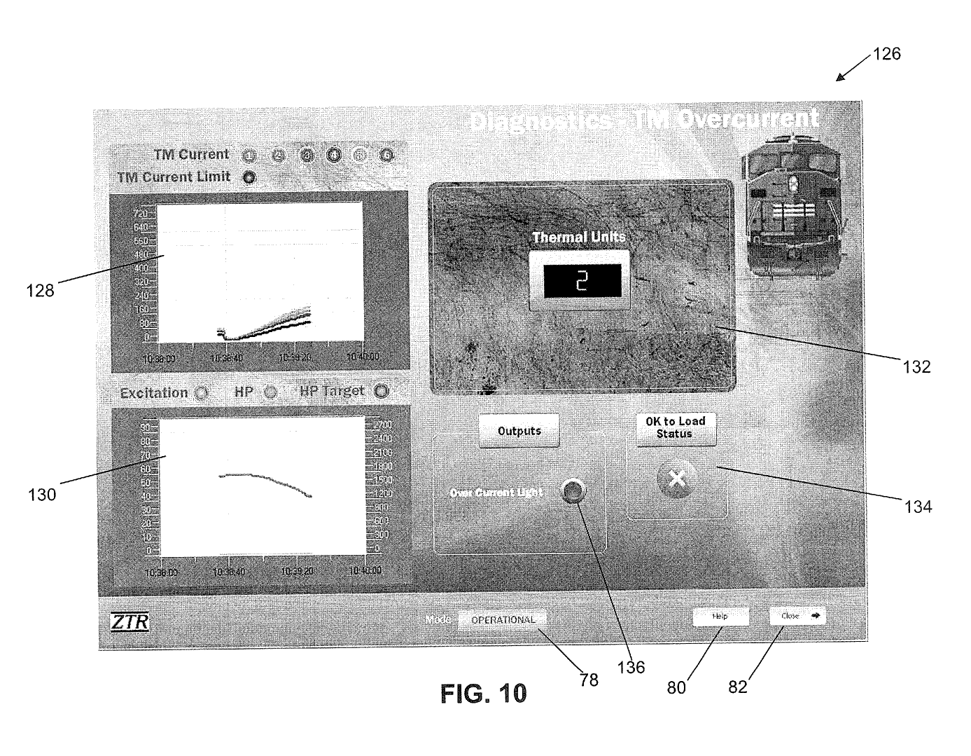

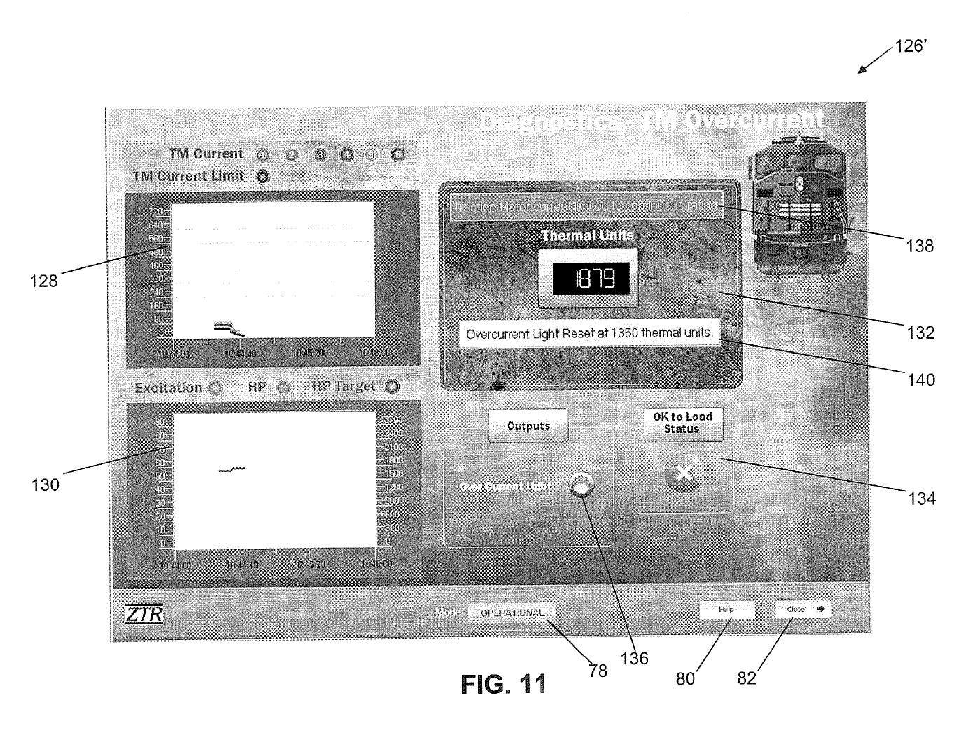

FIG. 10 illustrates a TM over current screen 126, which can be displayed by selecting the over current icon 51 in the main screen 36. The over current screen 126 displays a TM current graph 128 and an excitation graph 130 which are both updated in real time during an operational mode. A thermal units display 132 is also provided, along with the outputs, in this example the over current light 136, and an OK to Load status indicator 134. In FIG. 11, the over current screen 126′ is shown in another state, wherein an operator can see that the over current light 136 is on. A first notice 138 is also displayed in the thermal units display 132 that indicates the traction motor current is being limited to the continuous rating of the motor. A second notice 140 is also displayed to inform the operator that the thermal units should be 1350 before the over current condition will be reset. Therefore, it can be seen that various graphical indicators and notices (using colour not reflected in the figures) may be utilized to provide the operator with easy to understand information concerning a particular output or condition in the control system 12 for further diagnosis and remedy if appropriate.

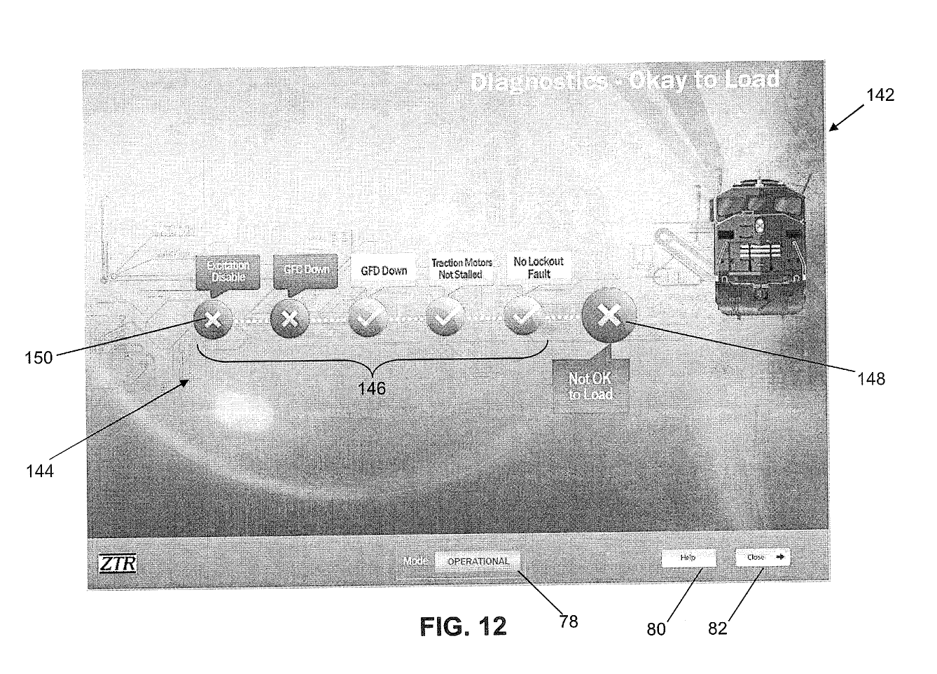

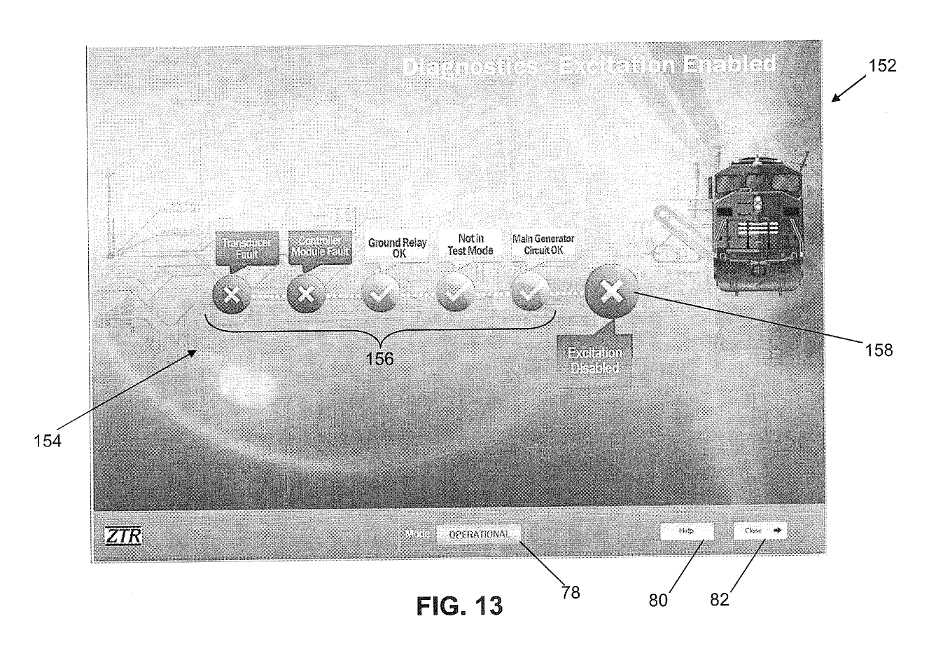

As illustrated in FIG. 5, to arrive at the output specific UI screens 66 or to simply identify root problems, the dependent outputs path 54 may be taken if applicable. One example is by selecting the Ok to Load icon 50 from the main screen 36, e.g. if that icon is red or otherwise indicates a problem. FIG. 12 illustrates a level I display in this case a main Okay to Load screen 142. The Okay to Load screen 142 includes a condition dependency mapping 144 for level I that includes a series of dependent conditions 146 that affect the Ok to Load condition 148, which in the example shown indicates that the locomotive 10 is no ok to load. The operator can see from the screen 142 that the unit is not ready to move and the status of the function in question is displayed with a large X and can be coloured red, etc. In this case, there are two unsatisfied conditions 146, namely the excitation is disabled as indicated by a first unsatisfied indicator 150, and GFC down. Since the excitation disabled condition is a dependent condition, by selecting the indicator 150, another diagnostic screen is opened as shown in FIG. 13.

FIG. 13 illustrates level II, which in this example provides an excitation enabled screen 152. Similar to at level I, the level II display includes a dependency mapping 154, with a series of dependent conditions 156 that lead to the unsatisfactory outcome 158, in this example “Excitation Disabled”. From this level II display, the operator can either immediately diagnose the unsatisfactory conditions transducer faults and controller module fault, or, if required and available, further information such as an analog screen 66 can be displayed by selecting the corresponding condition 156. In this way, the operator can drill down as far as necessary in order to diagnose the problem and if appropriate and available, further information can be provided, e.g. which transducer is faulty and which controller module is faulty. However, if the unsatisfactory conditions do not have any additional information and are root conditions, the fact that it is deemed and displayed as unsatisfactory provides the information necessary to remedy or at least further investigate the situation.

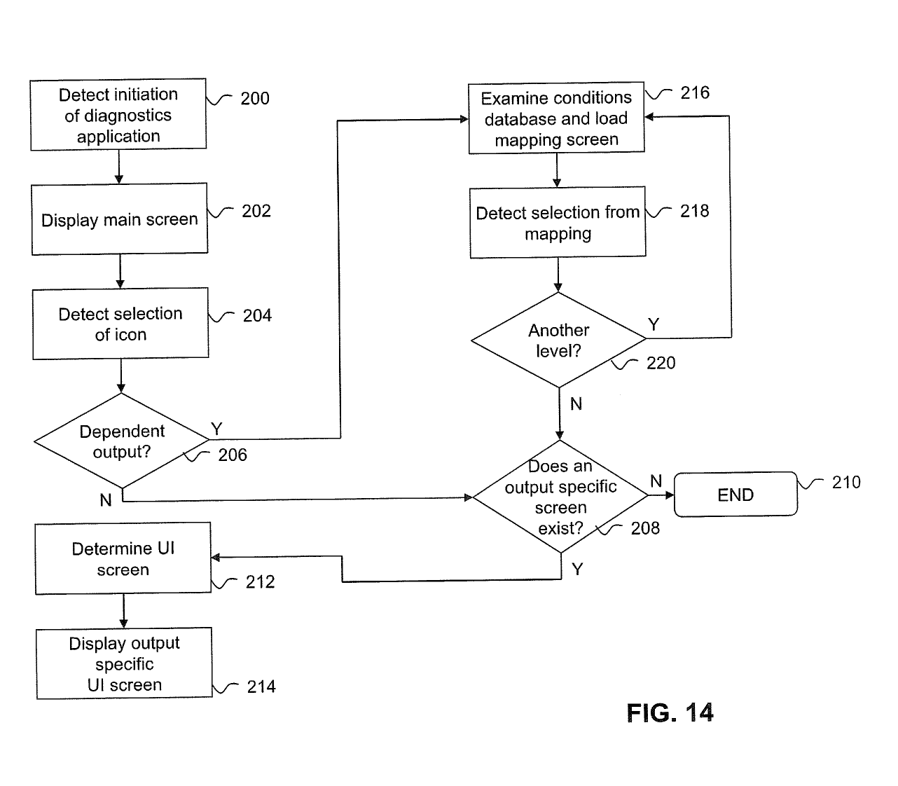

FIG. 14 illustrates a set of computer executable instructions that may be implemented in displaying the appropriate screens according to operator input. At step 200 the UI module 22 detects the initiation of the diagnostics application 16 and access the main screen 36 from the UI screens database 32 and displays the main screen 36 at step 202. The UI module 22 then at some later time detects selection of an icon 38 from the main screen 36 at step 204, and determines if the icon 38 is associated with a dependent output by referencing the conditions database 30 at step 306. If the selection is not associated with a dependent output, then the output specific path 56 may be taken by first determining if an output specific UI screen 66 exists at step 208. If an output specific UI screen 66 does not exist, the process ends at step 210 pending further input. If an output specific UI screen 66 does exist, the UI module 22 determines the associated UI screen from the UI screens database 32 at step 212, and displays the output specific UI screen 66 at step 214.

If the output examined at step 206 is a dependent output, the dependent outputs path 54 is taken by first examining the conditions database 30 and loading the appropriate mapping screen at step 216. It will be appreciated that steps 206 and 216 may be done simultaneously and are shown separately for illustrative purposes only. Once the mapping screen is loaded and displayed, the UI module may detect user input selecting a particular output from the mapping at step 218 and then determines at step 220 whether or not another level exists. If so, the next mapping screen is loaded by repeating steps 216 and 218. If not, the UI module 22 determines if an output specific UI screen 66 exists at step 208 as discussed above and proceeds with either steps 212 and 214 as above or ends the process pending further input at step 210.

Although the above has been described with reference to certain specific embodiments, various modifications thereof will be apparent to those skilled in the art without departing from the scope of the claims appended hereto.

1. A method for providing diagnostic information comprising:
detecting a first input indicative of selection of one of a plurality of conditions displayed on a main diagnostics screen;
determining if the selected condition has associated therewith, one or more dependent conditions;
if said selected condition has one or more dependent conditions, displaying a mapping of said dependent conditions on a new diagnostics screen, at least one of said dependent conditions indicating a problem associated therewith that causes a negative outcome; and
upon detecting a second input indicative of selection of said at least one of said dependent conditions, displaying a further mapping of dependent conditions if applicable or displaying diagnostic information associated with said at least one of said dependent conditions.

2. The method according to claim 1, further comprising:
if said selected condition does not have a dependent condition, displaying diagnostic information associated with said selected condition.

3. The method according to claim 1, wherein the displaying diagnostic information associated with said at least one of said dependent conditions comprises displaying a graphical user interface (GUI) comprising one or more parameters.

4. The method according to claim 3, wherein said GUI enables selection of one or more controls for operating a component of a control system.

5. The method according to claim 1, wherein said mappings comprise visual indicators for each of said dependent conditions, said visual indicators being indicative of a positive or negative outcome associated with a respective dependent condition.

6. The method according to claim 5, wherein the visual indicators are arranged to illustrate serial interdependencies, parallel interdependencies, or both, amongst the dependent conditions.

7. A computer readable storage medium comprising computer executable instructions for providing diagnostic information, the computer executable instructions comprising instructions for:
detecting a first input indicative of selection of one of a plurality of conditions displayed on a main diagnostics screen;
determining if the selected condition has associated therewith, one or more dependent conditions;
if said selected condition has one or more dependent conditions, displaying a mapping of said dependent conditions on a new diagnostics screen, at least one of said dependent conditions indicating a problem associated therewith that causes a negative outcome; and
upon detecting a second input indicative of selection of said at least one of said dependent conditions, displaying a further mapping of dependent conditions if applicable or displaying diagnostic information associated with said at least one of said dependent conditions.

8. The computer readable storage medium according to claim 7, further comprising instructions for:
if said selected condition does not have a dependent condition, displaying diagnostic information associated with said selected condition.

9. The computer readable storage medium according to claim 7, wherein the displaying diagnostic information associated with said at least one of said dependent conditions comprises displaying a graphical user interface (GUI) comprising one or more parameters.

10. The computer readable storage medium according to claim 9, wherein said GUI enables selection of one or more controls for operating a component of a control system.

11. The computer readable storage medium according to claim 7, wherein said mappings comprise visual indicators for each of said dependent conditions, said visual indicators being indicative of a positive or negative outcome associated with a respective dependent condition.

12. The computer readable storage medium according to claim 11, wherein the visual indicators are arranged to illustrate serial interdependencies, parallel interdependencies, or both, amongst the dependent conditions.

13. A system for providing diagnostic information, the system comprising a processor and memory, the memory comprising computer executable instructions for:
detecting a first input indicative of selection of one of a plurality of conditions displayed on a main diagnostics screen;
determining if the selected condition has associated therewith, one or more dependent conditions;
if said selected condition has one or more dependent conditions, displaying a mapping of said dependent conditions on a new diagnostics screen, at least one of said dependent conditions indicating a problem associated therewith that causes a negative outcome; and
upon detecting a second input indicative of selection of said at least one of said dependent conditions, displaying a further mapping of dependent conditions if applicable or displaying diagnostic information associated with said at least one of said dependent conditions.

14. The system according to claim 13, further comprising instructions for:
if said selected condition does not have a dependent condition, displaying diagnostic information associated with said selected condition.

15. The system according to claim 13, wherein the displaying diagnostic information associated with said at least one of said dependent conditions comprises displaying a graphical user interface (GUI) comprising one or more parameters.

16. The system according to claim 15, wherein said GUI enables selection of one or more controls for operating a component of a control system.

17. The system according to claim 13, wherein said mappings comprise visual indicators for each of said dependent conditions, said visual indicators being indicative of a positive or negative outcome associated with a respective dependent condition.

18. The system according to claim 17, wherein the visual indicators are arranged to illustrate serial interdependencies, parallel interdependencies, or both, amongst the dependent conditions.
